(19) United States
(12) Patent Application Publication
(10) Pub. No.: US 2002/0001701 A1
(43) Pub. Date: Jan. 3, 2002

(54) Conductive sheet containing conductive particles

(76) Inventor: Hitoshi Matsunaga, Tokyo (JP)

Correspondence Address: Pamela D. Politis, Ph.D., Ratner & Prestia, P.O. Box 7228, Wilmington, DE, 19803, US

(21) Appl. No.: 09/894,111

(22) Filed: Jun. 28, 2001

Related U.S. Application Data
(63) Continuation-in-part of application No. 09/507,018, filed on Feb. 22, 2000.

(30) Foreign Application Priority Data
Sep. 7, 1999 (JP) 11-253489

(51) Int. Cl. B32B 5/16

(52) U.S. Cl. 428/220; 428/327; 428/328

(57) ABSTRACT

A conductive sheet comprises: a plurality of elastic conductive particles each having an outer surface coated with a conductive material; and a thermostable dielectric resin having the conductive particles dispersed therein. The conductive sheet has a thickness of 1.5 mm or less. The conductive sheet is usable for electrically connecting electronic parts capable of performing the process at a high frequency clock speed. The sheet provides for rapid testing of electronic components by using the flexible sheet as a pressure dependent transmitter between electronic components.

This application is a Continuation-in-Part of U.S. patent Ser. No. 09/507,018 filed Feb. 22, 2000, which is pending and claims the priority of Japanese patent application number 11-253489, filed Sep. 7, 1999.

### BACKGROUND OF THE INVENTION

1. Field of the Invention

The present invention relates to a connecting device, such as a conductive sheet, for electrically connecting electronic parts, such as an integrated circuit including QFP, SOP, TSOP, BGA, CSP, LGA, MLP, QFN, and SON, hereinafter referred to as “IC” and a wafer, KGD, and a test tool for testing the electronic parts, and more particular, to a connecting device for repeatedly electrically connecting and disconnecting electronic parts required to perform the process at a high frequency clock speed.

2. Description of the Related Art

There have so far been provided with wide variety of connecting devices including a mechanical type of device, such as a probe pin, a prober, and a contact pin, and a chemical material type of device, such as an anisotropic conductive sheet.

One type of the conventional connecting device is disclosed as an anisotropically conductive and adhesive film in Japanese patent laid-open publication No. H07-14Q480. The anisotropically conductive and adhesive film comprises a dielectric adhesive material and a plurality of spherical polymer particles each having a rugged surface coated with a metal and uniformly dispersed in said dielectric adhesive material. The particles have an average diameter of 2-20 μm. The anisotropically conductive and adhesive film is interposed between a pair of electrodes. The electrodes and anisotropic conductive adhesive film are heated and pressed to electrically and mechanically connect the electrodes with each other through the adhesive film.

The improvement of the above anisotropically conductive and adhesive film is disclosed in Japanese patent laid-open publication No. H1O-245528 as anisotropically conductive joint member. The adhesive film comprises a small quantity of organic or inorganic ion exchanger combined with the dielectric adhesive material, in order to prevent the migration due to the deposition of the metal because of the fact that the metal of the electrode tends to dissociate into positive ion and to deposit on the cathode when the voltage is applied to the electrodes.

The other type of the conventional connecting device is disclosed in Japanese patent laid-open publication No. H11-54180 as a conductive sheet having conductivity only in a thicknesswise direction, in order to solve a problem of high electric resistance caused by the point electrical contact with respective conductive particulates. The thickness direction conductive sheet comprises: an insulating sheet; conductive particulates dispersed in the insulating sheet; and a plurality of conductive terminals arranged on at least one surface of the insulating sheet in order. The conductive terminals and corresponding terminals of a connecting object, such as a semiconductor element, are positioned, superposed on each other, and thermally press-fitted together to soften the insulating sheet. The conductive particulates are sunk in the insulating sheet, thereby making it possible to mechanically and electrically connect the conductive terminals and the corresponding terminals of the connecting object through the conductive particulates.

The aforesaid conventional connecting devices, however, have some problems to be solved. In the anisotropic ally conductive and adhesive film disclosed in Japanese patent laid-open publication No. HO7-140480, it is not only difficult to uniformly coat the spherical polymer particles each having a rugged surface with a metal but also apt to cause the disconnection between the particles due to their rugged surfaces.

The anisotropic ally conductive joint member disclosed in Japanese patent laid-open publication No. H10-245528 also has a problem of loss of its some properties due to the additional organic or inorganic ion exchanger.

In the thickness direction conductive sheet disclosed in Japanese patent laid-open publication No. H11-54180, the plurality of connecting terminals should be arranged in perfect order. This manufacturing process is troublesome, thereby bringing high cost.

### SUMMARY OF THE INVENTION

It is therefore an object of the present invention to provide a conductive sheet usable for electrically connecting electronic parts capable of performing the process at a high frequency clock speed.

According to this invention there is provided an electrically conductive connecting device for connecting a first electrical component to a second electrical component, the connecting device comprising:

a sheet having a first outer surface and a second outer surface and adapted to provide a conductive path between said top and said bottom surface, said sheet comprising a thermally stable dielectric elastic resin matrix formed into a non adhesive self supporting sheet having a thickness equal to or less than 1.5 mm, and a plurality of conductive particles dispersed in said matrix, said particles each comprising a dielectric resin core having an outer surface and a metal layer coated on said outer surface whereby applied pressure between said first and said second surfaces compresses said elastic resin matrix causing an electrically conductive path to form between said first and said second surfaces.

In accordance with a first aspect of the present invention, there is provided a conductive sheet comprising: conductive particles having elasticity and thermostability; and a dielectric resin being thermostable and having the conductive particles dispersed therein. The conductive sheet may have a thickness of 1.5 mm or less.

In the conductive sheet, each of the conductive particles may have a spherical shape having a diameter of 2 to 25 μm. Preferably, the conductive particles may have substantially two different average diameters including a first diameter range of 5 μm or less and a second diameter range of 7 μm or more. The average diameter of the particle means a substantially minimum diameter, which may be measured by a typical sedimentation velocity method.

In the conductive sheet, each of the conductive particles may be made of a dielectric material and has an outer surface coated with a conductive material. Alternatively, each of the conductive particles may be made of a polymer selected from among the group consisting of an organic polymer and an inorganic polymer. Each of the conductive particles may have its outer surface coated with a conductive material. In the conductive sheet, the conductive material may be selected from among the group consisting of gold, silver, copper, and alloys thereof.

The dielectric resin may be made of a polymer having elasticity and selected from among the group consisting of an organic polymer and an inorganic polymer. Alternatively, the dielectric resin may be made of a silicone resin.

### BRIEF DESCRIPTION OF THE DRAWINGS

The present invention and many of the advantages thereof will be better understood from the following detailed description when considered in connection with the accompanying drawing, wherein FIG. 1 is a sectional view of a conductive sheet according to the present invention.

FIG. 2 is a sectional view of a conductive sheet under local applied pressure according to the present invention.

### DESCRIPTION OF THE PREFERRED EMBODIMENTS

The present invention is a self supporting elastic polymer sheet that exhibits anisotropic electric conductivity by the incorporation of a plurality of conductive particles within the polymer sheet body. The elasticity of the sheet permits it to compress the sheet bringing into contact the conductive particles and thus forming a conductive path between the two surfaces of the sheet. Upon release of the pressure, the elasticity of the sheet returns the sheet to its original shape breaking the particle contact and the conductive path between the two sheet surfaces.

For the purposes of describing the present invention, “elasticity” is a property that indicates that the material is capable of withstanding and recovering from mechanical stresses. The present invention provides a conductive sheet for testing an IC by connecting electronic components. The electroconductive sheet is repeatedly deformable to provide electrical connection between sheet surfaces and to reform its shape to electrically disconnect the components. The term “elasticity” also describes the polymer which is used in forming the conductive sheet, as the polymer itself has elastic properties.

Thermostability is a property of a material that allows the material to withstand cycles of heat and cold without breakdown. The thermostability of the materials used in the present invention relate to heat and cold cycles as pertinent to the application of testing IC components.

Referring now to FIG. 1 of the drawing, there is-best shown an enlarged sectional view of the conductive sheet according to the present invention.

As shown in FIG. 1, the conductive sheet 10 has a first outer surface 21 and a second outer surface 22. The conductive sheet comprises conductive particles including relatively fine grains 12 and relatively coarse grains 14, and a matrix 16 made of a dielectric resin. The conductive sheet 10 has a thickness of 1.5 mm or less. Electronic parts to be electrically connected and disconnected through the sheet may be placed on the first surface 21 and the second surface 22, respectively.

The conductive particles including the fine grains 12 and the coarse grains 14 are mixed and uniformly dispersed into the matrix 16. The mixture is heated and rolled to form into a sheet having a thickness of 1.0-1.8 mm and then further pressed into a sheet of a thickness of 1.5 mm or less. More preferably, the thickness of the conductive sheet may be 0.7 mm or less. The thinner conductive sheet provides a more reliable connection than the thicker conductive sheet because a more direct transmission path may be formed by the conductive particles between the first and second surfaces.

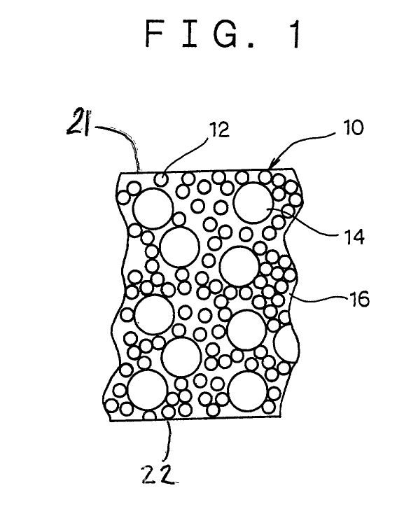

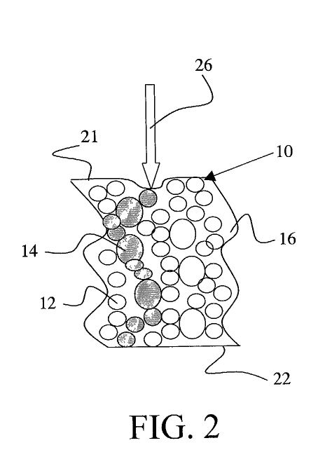

In the present instance as shown in FIG. 1 the conductive particles 12, 14 dispersed in the matrix 16 do not form a continuous path between the first 21 and second 22 surfaces. However, because the matrix is elastic it will deform under pressure and return to its original shape when the pressure is removed. This is illustrated schematically in FIG. 2. As pressure 26 is applied on the first 21 surface, the matrix 16 deforms locally. As the matrix deforms, the distance between the first and second surfaces decreases and the conductive particles are squeezed together. With the applied pressure, the conductive particles contact each other and form a conductive path between the first and second surfaces at the point where pressure is applied. An exemplary conductive path formed by the conductive particles when pressure is applied is shown shaded in FIG. 2.

The conductive sheet 10 is repeatedly deformable to assume a first position where the electronic parts placed on the first surface 21 and the second surface 22 are allowed to be electrically connected with each other through the conductive sheet 10 and a second position where the electronic parts are allowed to be electrically disconnected with each other through the conductive sheet 10.

This means that the conductive sheet 10 assumes the first position, as shown in FIG. 2, when a pressure is applied between the first surface 21 and the second surface 22 to compress the elastic resin matrix 16 causing an electrically conductive path to form between the first surface 21 and the second surface 22 and assumes the second position, shown in FIG. 1, when no pressure is applied between the first surface 21 and the second surface 22 to uncompress the elastic resin matrix 16 causing no electrically conductive path to form between the first surface 21 and the second surface 22. Each of the conductive particles 12 and 14 and the matrix 16 has elasticity to be particularly capable of withstanding and recovering from mechanical stresses caused by the pressure between the first surface 21 and the second surface 22. More specifically, the conductive sheet 10 performs a contact pressure of 10 to 100 g/pin when the pressure is applied between the first surface 21 and the second surface 22 to compress the matrix. The conductive sheet 10 is non adhesive and has elasticity to be capable of withstanding and recovering from the above pressure.

Preferably, each of the conductive particles 12 and 14 has a spherical shape having a diameter of 2 to 25 μm. The average diameter of the conductive particles may be large, i.e., 2 μm or more, enough to preserve its uniformity. There is almost no need to take the trouble to remove the small particles from the mixture.

More preferably, each of the conductive particles 12 and 14 is made of a polymer selected from among the group consisting of an organic polymer and an inorganic polymer. More particularly, each of the conductive particles 12 and 14 may have a relatively large rigidity. Preferably, the conductive particles may be made of a resin which can be molded into a spherical shape with ease. Because of the fact that the rigidity of the conductive sheet becomes large enough to lose its elasticity, the conductive sheet must not contain particles which are made of only metal.

Preferably, the thermostability of the conductive particles allow the particles to withstand heat and cold in the temperatures between −55° C. and +200° C.

Each of the conductive particles 12 and 14 has an outer surface coated with a conductive material, which may be, but not limited to, selected from among the group consisting of gold, silver, copper, aluminum, and alloys thereof. The coating of the metal may be made by the electroplating method, the electroless plating method or the other well-known coating methods. If the particles may be made of a polymer having conductivity, there will be no need to coat the particles with the conductive material.

The fine grains 12 may have a average diameter of 5 μm or less, while the coarse grains 14 may have an average diameter of 7 μm or more. The average diameter of the particles is a substantially minimum average outer diameter, which may be measured by a typical sedimentation velocity method.

Alternatively, each of the conductive particles may be an anisotropic shape, such as a needle shape and a fiber shape. The conductive particles may also have at least two different average diameters. The conductive sheet of this type is liable to attain conductivity even if the conductive sheet contains the relatively small number of anisotropic shaped particles. Alternatively, the conductive particles may be a mixture of spherical shaped particles and anisotropic shaped particles.

The dielectric resin used as the matrix 16 of the conductive sheet 10 may be made of a polymer having elasticity as well as thermostability. The dielectric resin may be selected from among the group consisting of an organic polymer and an inorganic polymer. The organic polymer may be, for example, polyimide, polyphenylene sulfide, a liquid crystal polymer, polyalylate, and the other general-purpose resins, such as polybutyrene terephthalate, polycarbonate, poly-I,4-cyclohexalie dimethylene terephthalate, polyethylene terephthalate, and polystyrene. The thermostable polymers are formed to retain elasticity in the conductive sheet and not provide adhesive properties. The materials are used to form a thermally stable, self-supporting film.

When the dielectric resin made of polyethylene terephthalate or polystyrene is formed into a sheet shape, and thereafter cooled and drawn into only one axis direction, the sheet formed dielectric resin tends to create micro-voids which is the size of a visible light frequency level. When the conductive sheet is heated and rolled, the conductive particles can move within the micro-voids. This results in the fact that the conductive sheet containing this type of dielectric resin can attain the electric connection between the conductive particles and the mechanical connection with a connecting object.

Preferably, the matrix may be made of a water-soluble dielectric resin. In this case, the mixture of the matrix having conductive particles dispersed therein may be then formed into a sheet by the well-known flow casting process.

The dielectric resin is preferably made of a silicone resin. The dielectric resin may add the other resin, such as a thermosetting resin and a thermoplastic resin, to the silicone resin. Alternatively, the silicone resin may be replaced with polyethylene terephthalate (PET), which is generally used as a polymer film. Polyethylene terephthalate sheets are used as non-adhesive self supporting films in the present invention, which may be referred to as a PET base. The result is a self supporting sheet, which may be later coated with additional layers.

The conductive sheet thus constructed has conductivity variable in accordance with a percentage of the conductive particulars having a diameter of 2-25 μm in the conductive sheet.

As many apparently widely different embodiments of this invention may be made without departing from the sprit and scope thereof, it is to be understood that the invention is not limited to the specific embodiments thereof except as defined in the appended claims.

What is claimed is:

1. An electrically conductive connecting device for connecting a first electrical component to a second electrical component, the connecting device comprising:
a sheet having a first outer surface and a second outer surface and adapted to provide a conductive path between the first and the second surfaces, said sheet comprising a thermally stable dielectric elastic resin matrix formed into a non adhesive self supporting sheet having a thickness equal to or less than 1.5 mm, and a plurality of conductive particles dispersed in said matrix, said particles each comprising an dielectric resin core having an outer surface and a metal layer coated on said outer surface, whereby applied pressure between said first and said second surfaces compresses said elastic resin matrix causing an electrically conductive path to form between said first and said second surfaces.

2. The electrically conductive connecting device according to claim 1 wherein said dielectric resin core is a sphere and has a diameter of from about 2 to about 25 micrometers.

3. The electrically conductive connecting device according to claim 1 wherein said particles comprise a first plurality of conductive spherical particles having a diameter of about 5 micrometers or less, and a second plurality of conductive particles having a diameter of about 7 micrometers or more.

4. The electrically conductive connecting device according to claim 1 wherein said metal layer comprises a metal selected from the group consisting of gold, silver, copper, alloys of gold, alloys of silver, alloys of copper and combinations thereof.

5. The electrically conductive connecting device according to claim 1 wherein said dielectric resin core is elastic and comprises a polymer.

6. The electrically conductive connecting device according to claim 5 wherein said polymer is an organic polymer, an inorganic polymer or a combination thereof.

7. The electrically conductive connecting device according to claim 6 wherein said metal layer comprises a metal selected from the group consisting of gold, silver, copper, alloys of gold, alloys of silver, alloys of copper and combinations thereof.

8. The electrically conductive connecting device according to claim 1 wherein said dielectric elastic resin matrix is an organic polymer, an inorganic polymer or a combination thereof.

9. The electrically conductive connecting device according to claim 1 wherein said dielectric elastic resin matrix is a silicone resin.
